(19) United States
(12) Patent Application Publication
(10) Pub. No.: US 2015/0109816 A1
(43) Pub. Date: Apr. 23, 2015

(54) LIGHT GUIDE PLATE, LIGHT SOURCE DEVICE, AND ELECTRONIC APPARATUS

(71) Applicant: NIKON CORPORATION, Tokyo (JP)

(72) Inventor: Takeshi YAGI, Tokyo (JP)

(73) Assignee: NIKON CORPORATION, Tokyo (JP)

(21) Appl. No.: 14/522,022

(22) Filed: Oct. 23, 2014

Related U.S. Application Data
(63) Continuation of application No. PCT/JP2013/062203, filed on Apr. 25, 2013.

(30) Foreign Application Priority Data
Apr. 27, 2012 (JP) 2012-102857

(51) Int. Cl. F21V 8/00

(52) U.S. Cl. CPC G02B 6/0023; G02B 6/0031; G02B 6/0035; G02B 6/0043
USPC 362/606; 362/317; 362/343; 362/351; 362/608

(57) ABSTRACT

A light guide plate configured to guide light which is incident on an incidence surface of a plate-shaped member so as to be emitted from an emission surface includes: a light amount adjusting unit configured to adjust the amount of light emitted from an excessive light amount region of the emission surface, wherein the light amount adjusting unit is provided on one of the incidence surface and the emission surface, corresponding to the excessive light amount region.

### CROSS-REFERENCE TO RELATED APPLICATION

This is a Continuation Application of International Application No. PCT/JP2013/62203 filed on Apr. 25, 2013, which claims priority on Japanese Patent Application No. 2012-102857 filed on Apr. 27, 2012, the contents of which are incorporated herein by reference.

### BACKGROUND

1. Field of the Invention

The present invention relates to a light guide plate, a light source device, and an electronic apparatus.

2. Background

In a mobile electronic apparatus such as a mobile phone, a PDA (Personal Digital Assistant), a notebook personal computer, a portable game machine, and a portable music player, a liquid crystal display device that displays a variety of information and images has been widely employed, and a display region is illuminated from the back surface side of a liquid crystal display panel by using a backlight (a light source device). In the backlight, light from the light source is incident to the lateral surface of a light guide plate to emit planar light from the emission surface (for example, top surface) of the light guide plate, and the liquid crystal display panel is widely illuminated (for example, refer to Japanese Patent Application, Publication No. 2011-44324A).

### SUMMARY

In a mobile electronic apparatus such as a mobile phone, it is necessary to enlarge a region in which a variety of information and images are displayed without increasing the size of the apparatus. Therefore, the display region is enlarged by narrowing a so-called frame portion which is a peripheral portion of the display region. In addition, it is also required to narrow the frame portion from the viewpoint of improved design of the electronic apparatus. In such a narrow frame configuration, since a light source is arranged at the frame portion, the light source becomes close to the display region. Thus, the light amount of a part of the display region, in particular, a region close to the light source becomes excessive, and uneven brightness is formed, which is a deterioration of display performance.

An object of an aspect of the present invention is to provide a technique to avoid the occurrence of uneven brightness in a display region by making the light amount of emitted light to be uniform in an emission surface and improve display performance while enlarging the display region.

An aspect of the present invention is a light guide plate configured to guide light which is incident on an incidence surface so as to be emitted from an emission surface, the light guide plate including: a light amount adjusting unit configured to adjust the amount of light emitted from an excessive light amount region of the emission surface, wherein the light amount adjusting unit is provided on one of the incidence surface and the emission surface, corresponding to the excessive light amount region.

Another aspect of the present invention is a light source device including: a light source; and a light guide plate configured such that light from the light source is incident on an incidence surface and the light is emitted from an emission surface, wherein the light guide plate is the above-described light guide plate.

Still another aspect of the present invention is a light source device including: a light source; a light guide plate configured such that light from the light source is incident on an incidence surface and the light is emitted from an emission surface; and a light amount adjusting unit configured to adjust the amount of light emitted from an excessive light amount region of the emission surface, wherein the light amount adjusting unit is provided at least one of on the light source and between the light source and the light guide plate, corresponding to the excessive light amount region.

Still another aspect of the present invention is an electronic apparatus including the above-described light source device.

According to an aspect of the present invention, it is possible to make a light amount to be uniform in an emission surface and avoid or prevent uneven brightness. In addition, it is possible to improve display performance.

### BRIEF DESCRIPTION OF THE DRAWINGS

FIG. 1 is a perspective view showing a light guide plate and a light source device according to an embodiment of the present invention.

FIG. 2 is a cross-sectional view showing a usage state of the light guide plate and the light source device.

FIG. 3 is a cross-sectional view showing an electronic apparatus according to the embodiment of the present invention.

FIG. 4 is a perspective view showing a light guide plate according to another embodiment.

FIG. 5 is a plan view showing a light guide plate and a light source device according to still another embodiment.

FIG. 6A is a plan view showing a light guide plate and a light source device according to still another embodiment.

FIG. 6B is a plan view showing a light guide plate and a light source device according to still another embodiment.

FIG. 6C is a plan view showing a light guide plate and a light source device according to still another embodiment.

FIG. 7 is a perspective view showing a light guide plate according to still another embodiment.

FIG. 8 is a cross-sectional view showing a usage state of the light guide plate and a light source device.

FIG. 9 is a cross-sectional view showing a light source device according to still another embodiment of the present invention.

FIG. 10 is a cross-sectional view showing a light source device according to still another embodiment of the present invention.

### DESCRIPTION OF THE EMBODIMENTS

Hereinafter, embodiments of the present invention will be described with reference to the drawings. In the drawings used for the following description, scales are suitably changed in order to make the size of each member and each unit recognizable.

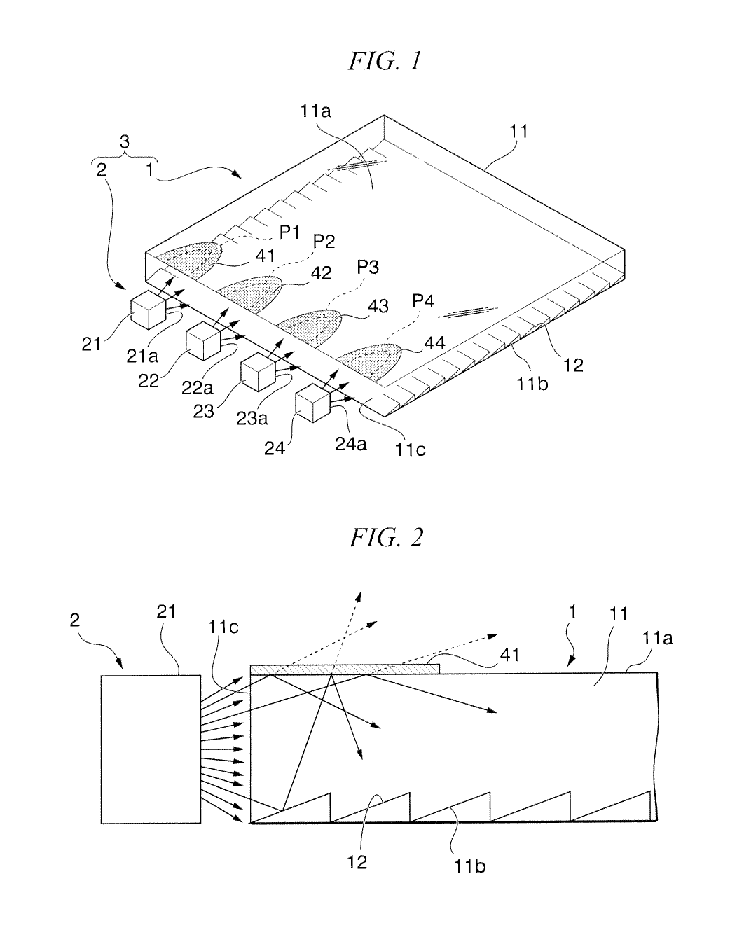

FIG. 1 and FIG. 2 are perspective views showing a light guide plate 1 and a light source device 3 according to an embodiment of the present invention. As shown in FIG. 1, a plate-shaped member 11 formed of a material that sufficiently transmits light in the visible light region, such as acrylic resin, polycarbonate, or a variety of glass is used for the light guide plate 1. The thickness of the plate-shaped member 11 is, for example, 30 μm to 500 μm. The numerical value is an example, and the invention is not limited thereto.

The surface (top surface in FIG. 1) of the plate-shaped member 11 is an emission surface 11a that emits planar light and is formed to be a smooth surface. The emission surface 11a may be applied with a surface treatment for diffusing light. In addition, a diffusion sheet or an optical sheet in which a micro prism is formed (not shown) may be attached to the entire emission surface 11a.

The surface treatment or attachment of the diffusion sheet is used not only for the purpose of adjusting the direction or broadening of light emitted from the emission surface 11a but for the purpose of making the shape of a structure unit 12 (the structure unit 12 is described below) of a back surface 11b to be invisible when the plate-shaped member 11 is seen from the emission surface 11a side.

The structure unit 12 of a saw shape having a plurality of reflection surfaces is formed on the back surface 11b of the plate-shaped member 11. Light introduced from an incidence surface 11c (lateral surface) of the plate-shaped member 11 is guided to the emission surface 11a side by the structure unit 12. The structure unit 12 is formed so that the angle or the size of each reflection surface is changed corresponding to the distance from the incidence surface 11c such that planar light emitted from the emission surface 11a becomes uniform.

The structure unit 12 is not limited to the configuration shown in FIG. 1. For example, the structure 12 may be a structure that guides light to the emission surface 11a by scattering or diffraction other than a structure that reflects light. In addition, instead of the structure unit 12 of a saw shape, a dot having a convex shape or a concave shape may be formed on the back surface 11b. The structure using a dot is configured such that the farther the dot is from the incidence surface 11c, the greater the area of the dot is, and thereby planar light emitted from the emission surface 11a becomes uniform.

A plurality of light emitters 21 to 24 are arranged at substantially equal intervals as a light source 2 on the incidence surface 11c side of the light guide plate 1. Light emitted from one of the light emitters 21 to 24 generates each of excessive light amount regions P1 to P4 on a portion of the emission surface 11a, the portion being close to the incidence surface 11e. The excessive light amount regions P1 to P4 are regions which can be recognized as having high brightness when seen by the human eye. One of light reduction units (light amount adjusting unit) 41 to 44 is formed on the emission surface 11a so as to include each of the excessive light amount regions P1 to P4.

As shown in FIG. 2, since the light reduction units 41 to 44 transmit part of light which travels from the inside of the plate-shaped member 11 toward the emission surface 11a and reflect the rest of the light, the light reduction units 41 to 44 function as a reflection unit. Thereby, the amount of light emitted from each of the excessive light amount regions P1 to P4 is reduced, and uneven brightness in planar light emitted from the emission surface 11a is avoided.

The light reduction units 41 to 44 are not limited to including the function as a reflection unit; however, one of the light reduction units 41 to 44 may be a light reduction unit, for example, which transmits part of light and absorbs the rest of the light. Further, the light reduction units 41 to 44 shown in FIG. 1 are each formed as a region which is slightly wider than the excessive light amount regions P1 to P4; however, one of the light reduction units 41 to 44 may be formed so as to be matched with each of the excessive light amount regions P1 to P4.

In the light source 2, an LED (Light Emitting Diode) is used as each of the light emitters 21 to 24. As the LED, a white LED or a pseudo-white LED configured to excite a yellow phosphor using a single-wavelength blue LED to obtain white color is used. The light source 2 is not limited to an LED, and a variety of light emitters such as a cold-cathode tube may be used. Further, the number and spacing of the light emitters 21 to 24 are not limited to those shown in FIG. 1 and can be arbitrarily set.

The light source 2 and the light guide plate 1 form the light source device 3. In addition to arranging the light source 2 and the light guide plate 1 such that a space is formed between the light source 2 and the light guide plate 1 as shown in FIG. 1 and FIG. 2, the space between the light source 2 and the light guide plate I may be filled with a transparent resin or the like. By filling the space between the light guide plate 1 and the light source 2 with a transparent resin or the like, the transparent resin or the like functions as an adhesive material, and the light guide plate 1 and the light source 2 are integrated. The refractive index of the transparent resin may he matched with the refractive index of the plate-shaped member 11 of the light guide plate 1.

Further, the light source device 3 shown in FIG. 1 is configured such that one lateral surface of the light guide plate 1 is the incidence surface 11c; however, the embodiment is not limited thereto. Two or more lateral surfaces of the plate-shaped member 11 may be the incidence surfaces, and the light source 2 may be provided on each of the lateral surfaces.

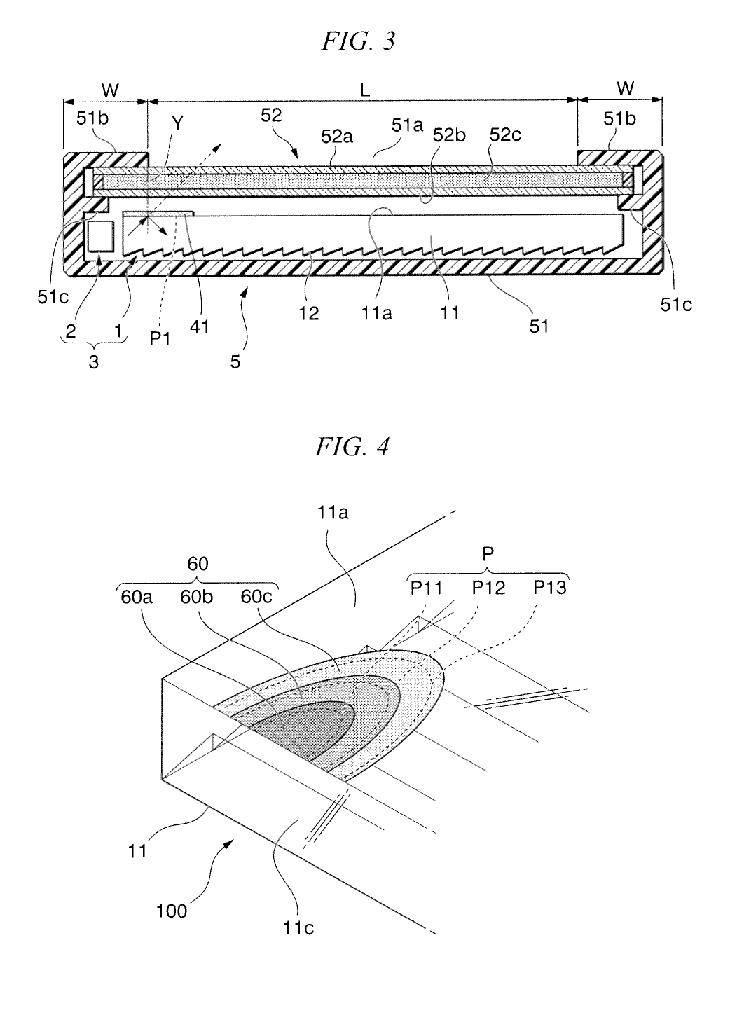

FIG. 3 is a cross-sectional view showing an embodiment of an electronic apparatus 5. The electronic apparatus 5 is a portable liquid crystal display device. The electronic apparatus 5 includes a housing 51. The housing 51 includes an aperture section 51a having a width L surrounded by a frame section 51b having a width W and houses the light source device 3 and a liquid crystal panel 52 inside the housing 51.

The liquid crystal panel 52 is configured by a glass substrate 52a on the front surface side which includes an individual electrode, a glass substrate 52b on the back surface side which includes a common electrode, and a liquid crystal layer 52c interposed between the glass substrate 52a and the glass substrate 52b. Further, the liquid crystal panel 52 is held by the housing 51 in a state where the peripheral portion of the liquid crystal panel 52 is interposed between the frame section 51b and a rib 51c. Thereby, the area having the width L of the aperture section 51a is used as the display region of the liquid crystal panel 52.

The liquid crystal panel 52 includes a polarization film arranged to interpose the glass substrates 52a, 52b, a driver for driving the liquid crystal, or the like (not shown). As the liquid crystal panel 52, a variety of known liquid crystal panels other than the liquid crystal panel shown in the drawing is used.

The light source device 3 is arranged on the glass substrate 52b side of the liquid crystal panel 52 in the housing 51 such that the emission surface 11a of the light guide plate 1 faces the liquid crystal panel 52. In this case, as shown in FIG. 3, the light source 2 is arranged in the area having the width W, on the back side of the frame section 51b. The light guide plate 1 is arranged in a state where the end portion is set into the back side of the frame section 51b such that part of the light guide plate 1 is positioned on the boundary Y between the area having the width L and the area having the width W. Thereby, the light reduction unit 41 on the emission surface 11a is arranged at a position which intersects with the boundary Y.

In the electronic apparatus 5 described above, when the light source 2 is turned on, light introduced into the light guide plate 1 from the incidence surface 11c is guided to the emission surface 11a by the structure unit 12 of the back surface to emit as planar light from the emission surface 11a, and the liquid crystal panel 52 is illuminated from the back surface side with the planar light. At this time, due to the light reduction unit 41, part of light which passes through the excessive light amount region P1 of the light guide plate 1 is emitted from the emission surface 11a, and the rest of the light is reflected into the plate-shaped member 11. Thereby, the amount of light emitted from the excessive light amount region P1 is reduced, and the liquid crystal panel 52 is illuminated in a state where uneven brightness on the emission surface 11a is avoided.

In FIG. 3, the excessive light amount region P1 is described. Similarly, in one of other excessive light amount regions P2 to P4, the light amount is adjusted by each of the light reduction units 42 to 44.

FIG. 4 is a perspective view showing a light guide plate 100 according to another embodiment.

In the emission surface 11a, the brightness in an excessive light amount region P is not uniform, and the brightness is decreased in accordance with the position being farther from the light source 2. Accordingly, in the uniform light reduction units 41 to 44 as shown in FIG. 1, there may be a case where, for example, a portion through which large amount of light is transmitted or a portion in which transmission is suppressed beyond necessity occurs, and uneven brightness remains in the excessive light amount region P. In particular, such a case easily occurs when the excessive light amount region P is large.

On the other hand, in the light guide plate 100 shown in FIG. 4, the excessive light amount region P is divided into a high brightness part P11, a middle brightness part P12, and a low brightness part P13 in this order from the region close to the incidence surface 11c (close to the light source), and a light reduction unit (light amount adjusting unit) 60 which is divided into a high light reduction unit 60a, a middle light reduction unit 60b, and a low light reduction unit 60c is formed such that one of the units 60a to 60c corresponds to each of the parts P11 to P13. Thereby, the amount of light which is transmitted through the high light reduction unit 60a is greatly restricted, and the amount of light which is transmitted through the middle light reduction unit 60b and the low light reduction unit 60c increases in this order. Thus, the amount of transmission light in the excessive light amount region P is changed in a step-by-step manner.

In this way, by dividing the light reduction unit 60 and finely adjusting the light amount, uneven brightness in the excessive light amount region P is avoided, and furthermore, uneven brightness in the entire emission surface 11a is avoided. In particular, the light reduction unit 60 is advantageous for avoiding uneven brightness when the excessive light amount region P is large.

As the high light reduction unit 60a, the middle light reduction unit 60b, and the low light reduction unit 60c, a type of the light reduction unit shown in FIG. 1 and FIG. 2 which transmits part of light and reflects the rest of the light is used. Alternatively and/or additionally, a type of the light reduction unit which transmits part of light and absorbs the rest of the light may be used.

In addition, the light reduction unit 60 shown in FIG. 4 is formed to be divided into three regions; however, the embodiment is not limited thereto. The light reduction unit 60 may be formed to be divided into two regions or four or more regions. Further, as the light reduction unit 60, a light reduction unit that smoothly changes the amount of transmitted light may be used.

The light guide plate 100 shown in FIG. 4 has a structure unit on the back surface side of the plate-shaped member 11 similarly to the light guide plate 1 shown in FIG. 1 and FIG. 2. Further, the light guide plate 100 shown in FIG. 4 and a variety of light sources arranged on the incidence surface 11c side of the light guide plate 100 may be combined as the light source device. Further, this light source device may be used instead of the light source device 3 shown in FIG. 3 to thereby provide the electronic apparatus.

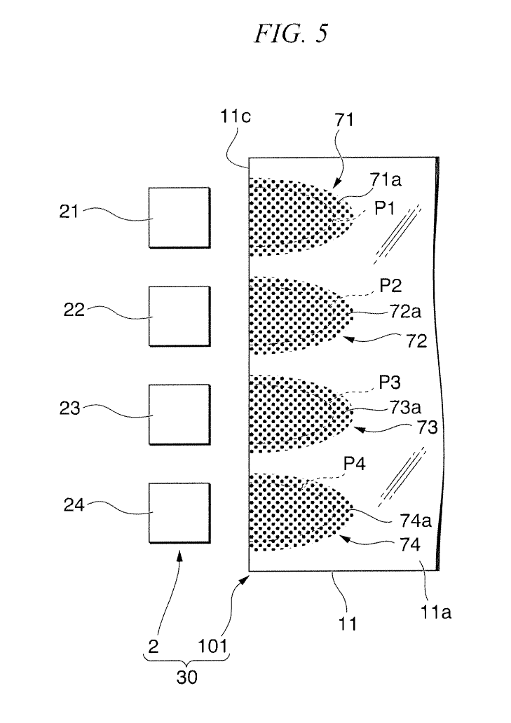

FIG. 5 is a plan view showing a light guide plate 101 and a light source device 30 according to still another embodiment.

The light source 2 and the plate-shaped member 11 in FIG. 5 are the same as those shown in FIG. 1, and the description of each part is omitted. In the light guide plate 101, one of light shield units (light amount adjusting unit) 71 to 74 is formed corresponding to each of excessive light amount regions P1 to P4 in the emission surface 11a of the plate-shaped member 11. One of the light shield units 71 to 74 is formed by scattering each of dot units 71a to 74a in each of the excessive light amount regions P1 to P4, each of the dot units 71a to 74a being a metal film such as chromium.

In the light shield unit 71, light incident on the dot 71a, the light being part of light that arrives at the excessive light amount region P1 from the inside of the plate-shaped member 11, is reflected and returns to the inside of the plate-shaped member 11, and light which passes through the gap between the dots 71a is directly emitted from the emission surface 11a. In such a way, by shielding transmission of light using the dot 71a, the amount of light which passes through the excessive light amount region P1 is reduced.

Similarly, the amount of light which passes through one of the other excessive light amount regions P2 to P4 is also reduced by each of the light shield units 72 to 74. Thereby, uneven brightness in planar light emitted from the emission surface 11a is avoided.

In the light shield units 71 to 74 shown in FIG. 5, the dot units 71a to 74a have the function as a reflection unit; however, the embodiment is not limited thereto. A dot unit which is formed of a metal or a resin capable of absorbing light may be used.

Further, the size or the shape of each of the dot units 71a to 74a is arbitrary; however, by using a small dot unit, it is possible to make the light shield units 71 to 74 less visible when the light shield units 71 to 74 are seen from the emission surface 11a side. Light which is transmitted through the light shield units 71 to 74 is adjusted by the size or the density per unit area of the dot units 71a to 74a.

Further, the embodiment is not limited to the arrangement of the dot units 71a to 74a being uniform in the excessive light amount region P, and the arrangement may be changed in the excessive light amount region P.

For example, a configuration can be used in which a large amount of light is shielded on the incidence surface 11c side by making the density of the dot unit 71a high or by using a large dot unit 71a, and a smaller amount of light is shielded corresponding to the dot unit 71a being farther from the incidence surface 11c by making the density of the dot unit 71a lower or by making the dot unit 71a smaller. Thereby, the transmission light amount is made uniform in the excessive light amount region P, and it is possible to avoid uneven brightness in the entire emission surface 11a.

The light source device 30 includes the light guide plate 101 and the light source 2. A variety of light sources can be used as the light source 2, similarly to the light source device 3 shown in FIG. 1. Further, the light source device 30 may be used instead of the light source device 3 shown in FIG. 3 to thereby provide the electronic apparatus.

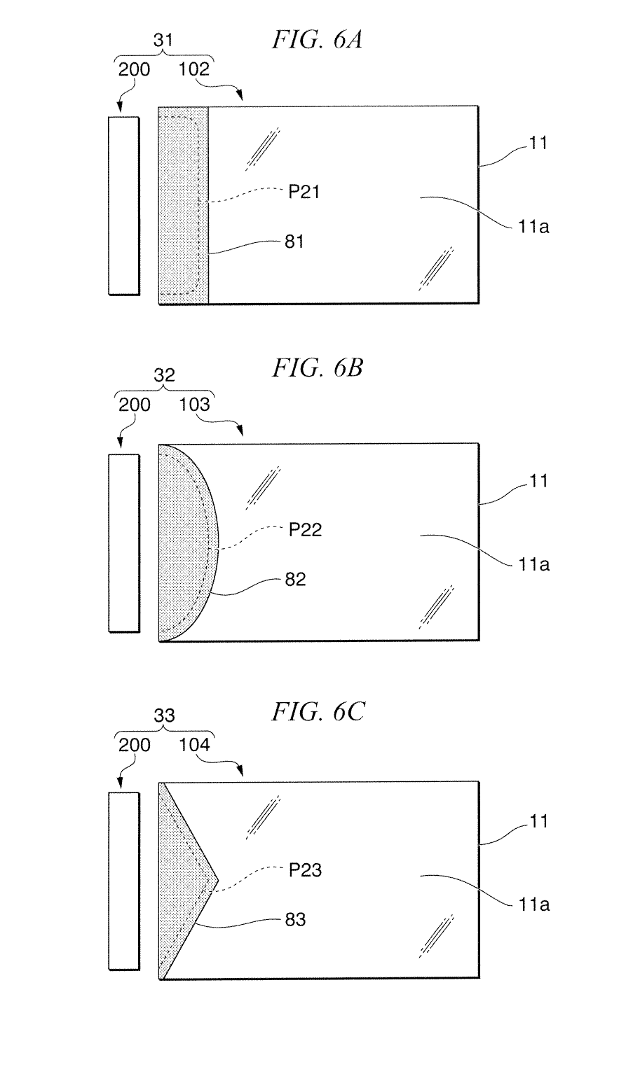

One of FIGS. 6A to 6C is a plan view showing each of light guide plates 102, 103, 104 and each of light source devices 31, 32, 33 according to still another embodiment. The plate-shaped member 11 in each of FIGS. 6A to 6C is the same as that shown in FIG. 1, and the description of the member is omitted. In FIGS. 6A to 6C, a cold-cathode tube is used as a light source 200.

In the light guide plate 102 of FIG. 6A, when an excessive light amount region P21 is formed in a band shape on the emission surface 11a, a band-shaped light reduction unit (light amount adjusting unit) 81 which corresponds to the excessive light amount region P21 is formed.

In the light guide plate 103 of FIG. 6B, when an excessive light amount region P22 is formed in a shape having a curved boundary (part of a circular shape or an elliptical shape) on the emission surface 11a, a light reduction unit (light amount adjusting unit) 82 having a shape which corresponds to the excessive light amount region P22 is formed.

In the light guide plate 104 of FIG. 6C, when an excessive light amount region P23 is formed in a substantially triangular shape on the emission surface 11a, a light reduction unit (light amount adjusting unit) 83 having a substantially triangular shape which corresponds to the excessive light amount region P23 is formed.

In FIG. 6A, the light guide plate 102 and the light source 200 form the light source device 31. In FIG. 6B, the light guide plate 103 and the light source 200 form the light source device 32. In FIG. 6C, the light guide plate 104 and the light source 200 form the light source device 33. The light source devices 31, 32, 33 are used instead of the light source device 3 of the electronic apparatus 5 shown in FIG. 3.

FIGS. 6A to 6C are described using an example in which the light source 200 is a cold-cathode tube; however, the excessive light amount regions P21 to P23 as shown in FIGS. 6A to 6C may occur, for example, when the light emitters 21 to 24 as shown in FIG. 1 are arranged in a narrow spacing or the like. In such a case, one of the light reduction units 81 to 83 can be formed for each of the excessive light amount regions P21 to P23.

FIGS. 6A to 6C are described using an example in which each of the light reduction units 81 to 83 is used as the light amount adjusting unit; however, the light transmittance may be changed in the same manner as the light reduction unit 60 shown in FIG. 4. Further, as the light reduction units 81 to 83, a light shield unit using a dot unit may be used like the light shield units 71 to 74 using the dot units 71a to 74a shown in FIG. 5.

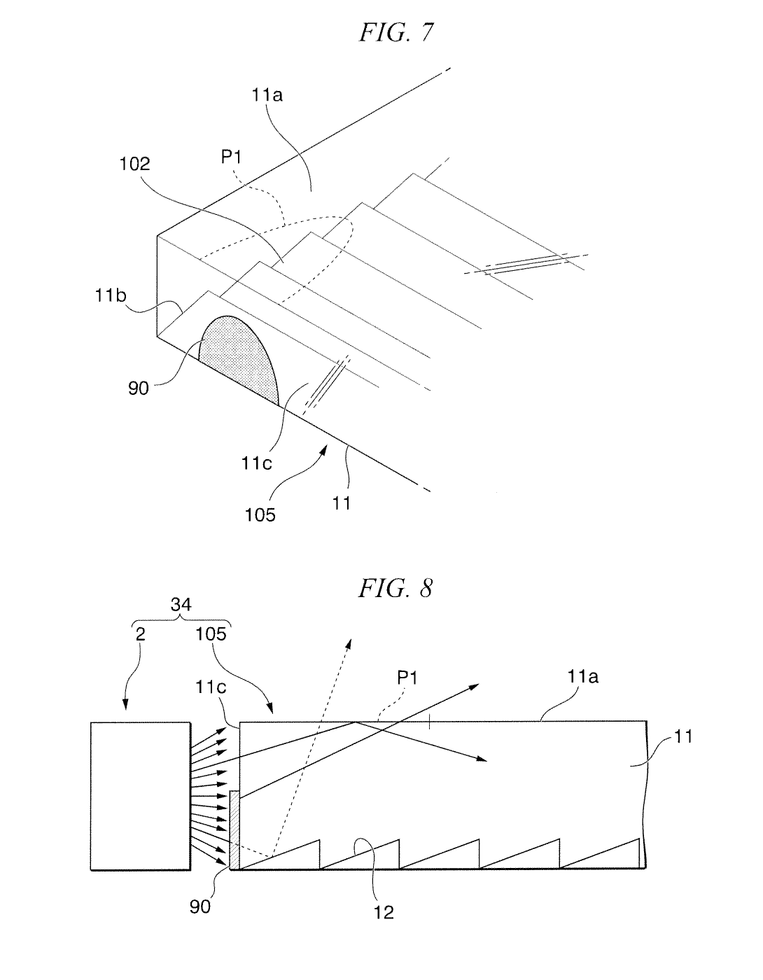

Each of FIG. 7 and FIG. 8 is a diagram showing a light guide plate 105 and a light source device 34 according to still another embodiment. The plate-shaped member 11 in FIG. 7 and FIG. 8 is the same as that shown in FIG. 1, and the description of the member is omitted.

In the light guide plate 105 in FIG. 7, a light reduction unit (light amount adjusting unit) 90 is provided on the incidence surface 11c of the plate-shaped member 11. The light reduction unit 90 is provided in a semicircular shape on a portion facing the light source 2 of the incidence surface 11c from the back surface 11b side.

The shape and position of the light reduction unit 90 are determined in relation to the light source 2. That is, the shape and position of the light reduction unit 90 are determined based on the shape and direction of light emitted from the light source 2 and moreover the distance between the light source 2 and the light guide plate 105 such that light emitted from the excessive light amount region P1 is reduced. Accordingly, depending on the used light source, a light reduction unit may be formed on a portion close to the emission surface 11a of the incidence surface 11c or a central portion of the emission surface 11c, instead of the light reduction unit 90 shown in FIG. 7. In addition, a quadrilateral shape or the like may be used as the shape of the light reduction unit.

FIG. 7 is described using an example in which the light reduction unit 90 is used as the light amount adjusting unit; however, the light transmittance may be changed in the same manner as the light reduction unit 60 shown in FIG. 4. Further, as the light reduction unit 90, a light shield unit using a dot unit may be used like the light shield units 71 to 74 using the dot units 71a to 74a shown in FIG. 5.

In the light guide plate 105, the amount of light which passes through the light reduction unit 90 is adjusted (reduced). As a result, light emitted from the excessive light amount region P1 is reduced, and uneven brightness of the emission surface 11a is avoided.

Further, as shown in FIG. 8, the light source device 34 includes the light guide plate 105 and the light source 2. A variety of light sources can he used as the light source 2, similarly to the light source device 3 shown in FIG. 1. Further, the light source device 34 may be used instead of the light source device 3 shown in FIG. 3 to thereby provide the electronic apparatus.

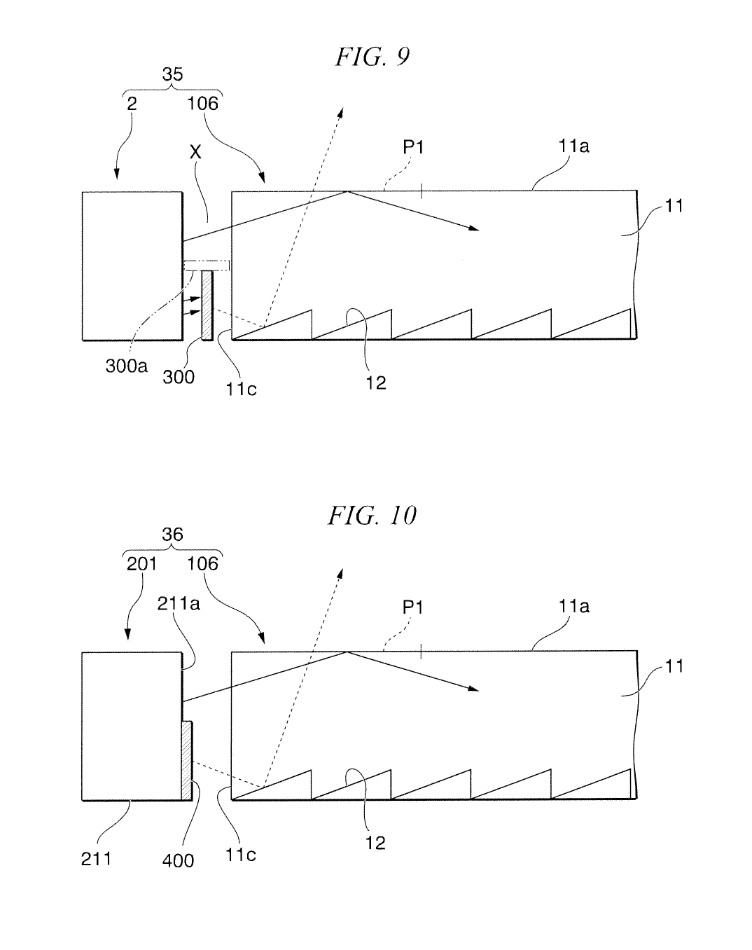

FIG. 9 is a cross-sectional view showing a light source device 35 according to still another embodiment. The light source device 35 includes the light source 2 and a light guide plate 106, and a light reduction unit 300 is provided as the light amount adjusting unit in a space X between the light source 2 and the light guide plate 106. The light source 2 and the plate-shaped member 11 in FIG. 9 are the same as those shown in FIG. 1, and the description of each part is omitted. The light guide plate 106 does not include the light amount adjusting unit on the emission surface 11a or the incidence surface 11c, differently from the above-described light guide plate 1 or the like.

A member having a plate shape and formed of a material which reduces the amount of transmission light is used as the light reduction unit 300, and the light reduction unit 300 is arranged in substantially parallel with the incidence surface 11c. The light reduction unit 300 is held at a predetermined position in the space X by another member. Alternatively and/or additionally, the light reduction unit 300 is held by filling the space X with a transparent resin or the like.

The light reduction unit 300 is arranged at a position such that the amount of light emitted from the excessive light amount region P1 is reduced, the light being part of light incident on the light guide plate 106 from the light source 2. Accordingly, the position of the light reduction unit 300 is determined based on a variety of situations such as the type of the light source 2, the direction or the shape of emitted light, and the size of the space X; and the embodiment is not limited to the arrangement as shown in FIG. 9. The position of the light reduction unit 300 is appropriately determined, for example, to a position on the emission surface 11 a side in the space X, a central position in the space X, a position close to the light source 2, a position close to the light guide plate 106, and the like. Further, the direction of the light reduction unit 300 is also not limited to being parallel to the incidence surface 11c. The light reduction unit 300 may be arranged in parallel with the emission direction of light from the light source 2, like a light reduction unit 300a.

Further, FIG. 9 is described using an example in which the light reduction unit 300 is used as the light amount adjusting unit; however, the light transmittance may be changed in the same manner as the light reduction unit 60 shown in FIG. 4. Further, as the light reduction unit 300, a light shield unit using a dot unit may be used like the light shield units 71 to 74 using the dot units 71a to 74a shown in FIG. 5.

In the light source device 35, since the amount of light emitted from the excessive light amount region P1 is reduced by the light reduction unit 300 (300a) before light emitted from the light source 2 is incident on the light guide plate 106, uneven brightness in planar light emitted from the emission surface 11a is avoided. A variety of light sources can be used as the light source 2, similarly to the light source device 3 shown in FIG. 1. Further, the light source device 35 may be used instead of the light source device 3 shown in FIG. 3 to thereby provide the electronic apparatus.

FIG. 10 is a cross-sectional view showing a light source device 36 according to still another embodiment. The light source device 36 includes a light reduction unit 400 on the light source 201 as the light amount adjusting unit. The light guide plate 106 in FIG. 10 is the same as that shown in FIG. 9, and the description of the plate is omitted.

The light reduction unit 400 is provided on an emission surface 211a of a light emitter 211 of the light source 2. An LED is used for the light emitter 211 of the light source 201; however, the embodiment is not limited thereto. A variety of light emitters such as a cold-cathode tube are used.

The light reduction unit 400 is provided at a position such that the amount of light emitted from the excessive light amount region P1 is reduced, the light being part of light emitted from the light source 2. Accordingly, the position of the light reduction unit 400 is determined depending on the type of the light source 2 and the direction or the shape of emitted light; and the position of the light reduction unit 400 is not limited to the position as shown in FIG. 10. For example, the light reduction unit 400 may be provided on a portion close to the upper portion (the emission surface 11a side of the light guide plate 106) of the emission surface 211a or a central portion of the emission surface 211a.

Further, FIG. 10 is described using an example in which the light reduction unit 400 is used as the light amount adjusting unit; however, the light transmittance may be changed in the same manner as the light reduction unit 60 shown in FIG. 4. Further, as the light reduction unit 400, a light shield unit using a dot unit may be used like the light shield units 71 to 74 using the dot units 71a to 74a shown in FIG. 5.

In the light source device 36, light emitted from the light source 201 is incident on the light guide plate 106 in a state where the amount of part of light is reduced by the light reduction unit 400. Thereby, the amount of light emitted from the excessive light amount region P1 is reduced, and therefore uneven brightness in planar light emitted from the emission surface 11a is avoided. The light source device 36 may be used instead of the light source device 3 shown in FIG. 3 to thereby provide the electronic apparatus.

Hereinbefore, the embodiments of the invention are described in detail with reference to the accompanying drawings, but specific configurations are not limited to the embodiments and include a design or the like made in a range without departing from the scope of the invention. For example, the embodiments described above may be combined. Several types of light amount adjusting units may be provided on one light guide plate by appropriately combining the light reduction unit 41 of FIG. 1, the light shield unit 71 of FIG. 5, the light reduction unit 90 of FIG. 7, and the like. Further, as the light source device, the light guide plates 1, 100 to 105 shown in FIG. 1 to FIG. 8 may be used instead of the light guide plate 106 of the light source device 35 of FIG. 9 or the light source device 36 of FIG. 10.

One embodiment is the light guide plate 1, 105 that guides light which is incident on the lateral surface 11c so as to be emitted from the emission surface 11a, the light guide plate including: a light amount adjusting unit that is formed on the emission surface 11a or the lateral surface 11c and adjusts the amount of light emitted from the excessive light amount regions P1 to P4 of the emission surface 11a.

In the embodiment, the light amount adjusting unit can be the light shield unit, the light reduction units 41 to 44, 90, or a combination of the light shield unit and the light reduction units.

In addition, the light amount adjusting unit can include the reflection unit that reflects part of or the whole of light which arrives at the light amount adjusting unit.

One embodiment is the light guide plate 100 that guides light which is incident on the lateral surface 11c so as to be emitted from the emission surface 11a, the light guide plate including: a light amount adjusting unit that is formed on the emission surface 11a, adjusts the amount of light emitted from the excessive light amount region P of the emission surface 11a, and is configured by the light reduction unit 60 in which the transmittance in the excessive light amount region P is changed in a step-by-step manner.

In addition, one embodiment is the light guide plate 101 that guides light which is incident on the lateral surface 11c so as to he emitted from the emission surface 11a, the light guide plate including: a light amount adjusting unit formed on the emission surface 11a and configured by the light shield units 71 to 74 in one of which, each of the dot units 71a to 74a of a metal film for adjusting the amount of light emitted from each of the excessive light amount regions P1 to P4 of the emission surface 11a is scattered.

1. A light guide plate configured to guide light which is incident on an incidence surface so as to be emitted from an emission surface, the light guide plate comprising:
a light amount adjusting unit configured to adjust the amount of light emitted from an excessive light amount region of the emission surface, wherein
the light amount adjusting unit is provided on one of the incidence surface and the emission surface, corresponding to the excessive light amount region.

2. The light guide plate according to claim 1, wherein
the light amount adjusting unit is a light reduction unit configured to reduce the amount of light emitted from the light amount adjusting unit.

3. The light guide plate according to claim 2, wherein
the light reduction unit transmits part of light which arrives at the light reduction unit and reflects the rest of the light.

4. The light guide plate according to claim 2, wherein
the light reduction unit transmits part of light which arrives at the light reduction unit and absorbs the rest of the light.

5. The light guide plate according to claim 3, wherein
in the light reduction unit, the transmittance with respect to the light is changed in a step-by-step manner.

6. The light guide plate according to claim 2, wherein
the light reduction unit includes a light shield unit in which a dot unit is scattered.

7. The light guide plate according to claim 6, wherein
the dot unit is formed of a metal film.

8. A light source device comprising:
a light source; and
a light guide plate configured such that light from the light source is incident on an incidence surface and the light is emitted from an emission surface, wherein
the light guide plate is the light guide plate according to claim 1.

9. A light source device comprising:
a light source;
a light guide plate configured such that light from the light source is incident on an incidence surface and the light is emitted from an emission surface; and
a light amount adjusting unit configured to adjust the amount of light emitted from an excessive light amount region of the emission surface, wherein
the light amount adjusting unit is provided at least one of on the light source and between the light source and the light guide plate, corresponding to the excessive light amount region.

10. An electronic apparatus comprising the light source device according to claim 8.
